(19) United States
(12) Patent Application Publication
(10) Pub. No.: US 2025/0286576 A1
(43) Pub. Date: Sep. 11, 2025

(54) RADIO FREQUENCY FRONT END ARCHITECTURE WITH ANTENNA SWAPPING

(71) Applicant: Skyworks Solutions, Inc., Irvine, CA (US)

(72) Inventor: John Chi-Shuen Leung, Foothill Ranch, CA (US)

(21) Appl. No.: 19/074,210

(22) Filed: Mar. 7, 2025

Related U.S. Application Data
(60) Provisional application No. 63/563,221, filed on Mar. 8, 2024.

(51) Int. Cl. H04B 1/40; H04B 7/0413

(52) U.S. Cl. CPC H04B 1/40; H04B 7/0413

(57) ABSTRACT

A radio frequency front end system has a primary transmit and receive module with at least one transmit path, at least one first receive path, at least two first antenna ports, and at least one first controllable switch configured to switch between the at least two first antenna ports. A first secondary radio frequency module includes at least one second receive path, at least two second antenna ports, and at least one second controllable switch configured to switch between the at least two second antenna ports. A first antenna port of the at least two first antenna ports is configured for direct connection to a first antenna. A second antenna port of the at least two first antenna ports configured for indirect connection to a second antenna.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to radio frequency (RF) front-end (RFFE) systems providing signal paths from any mid and high band (MHB) module to any antenna of an antenna array connected to the RFFE system.

### Description of the Related Technology

RF communication systems can be used for transmitting and/or receiving signals of a wide range of frequencies. For example, an RF communication system can be used to wirelessly communicate RF signals in a frequency range of about 30 kHz to 300 GHz, such as in the range of about 450 MHz to about 7.125 GHz for certain communications standards, e.g., Fifth Generation (5G) cellular communications.

Examples of RF communication devices include, but are not limited to, mobile phones, tablets, base stations, network access points, customer-premises equipment (CPE), laptops, and wearable electronics. An RF device can include multiple antennas for supporting communications. Additionally, the RF device can include an RFFE system for processing signals received from and transmitted to the antennas. The RFFE system can provide a number of functions, including, but not limited to, signal filtering, controlling component connectivity to the antennas, and/or signal amplification.

### SUMMARY

In some aspects, the techniques described herein relate to a radio frequency front-end system including a plurality of mid and high band modules, each mid and high band module of the plurality of mid and high band modules including: at least two antenna ports; and at least one controllable switch configured to switch between the at least two antenna ports to provide a signal path from the mid and high band module to a selected antenna of an antenna array connected to the radio frequency front-end system.

In some aspects, the techniques described herein relate to a radio frequency front-end system wherein each of the plurality of mid and high band modules further includes an integrated module controller configured to control the at least one controllable switch.

In some aspects, the techniques described herein relate to a radio frequency front-end system wherein the integrated module controller is configured to control the at least one controllable switch in response to a control signal received from an external master controller.

In some aspects, the techniques described herein relate to a radio frequency front-end system wherein the plurality of mid and high band module includes at least one primary transmit and receive module configured to be switched for normal transmission of a transmission signal to a primary antenna of the antenna array having a high antenna efficiency and being connected directly to an antenna port of the at least one primary transmit and receive module.

In some aspects, the techniques described herein relate to a radio frequency front-end system wherein the at least one primary transmit and receive module is configured to be switched for subsidiary transmission of a transmission signal to a secondary antenna of the antenna array connected indirectly to an antenna port of the at least one primary transmit and receive module by a signal path via one or more secondary mid and high band modules of the plurality of mid and high band modules.

In some aspects, the techniques described herein relate to a radio frequency front-end system wherein the plurality of mid and high band modules include mid and high band multi-input and multi-output modules configured to process a reception signal of an antenna of the antenna array.

In some aspects, the techniques described herein relate to a radio frequency front-end system wherein each mid and high band multi-input and multi-output module includes two antenna ports.

In some aspects, the techniques described herein relate to a radio frequency front-end system wherein the plurality of mid and high band modules includes at least one diversity receive module configured to process a reception signal of an antenna of the antenna array.

In some aspects, the techniques described herein relate to a radio frequency front-end system wherein the at least one diversity receive module includes two antenna ports.

In some aspects, the techniques described herein relate to a radio frequency front-end system wherein the at least one primary transmit and receive module includes three antenna ports, a first antenna port of the at least one primary transmit and receive module is connected directly to a primary antenna of the antenna array, and a second antenna port and a third antenna port of the at least one primary transmit and receive module are switchable via secondary mid and high band modules to secondary or tertiary antennas of the antenna array.

In some aspects, the techniques described herein relate to a radio frequency front-end system wherein the at least one controllable switch of each of the plurality of mid and high band modules includes a double-pole multi-throw switch controlled by an integrated module controller of each of the plurality of mid and high band modules.

In some aspects, the techniques described herein relate to a radio frequency front-end system wherein the at least one primary transmit and receive module includes a double-pole multi-throw switch configured to switch between a first antenna port of the at least one primary transmit and receive module connected directly to a primary antenna of the antenna array and a second or a third antenna port of the at least one primary transmit and receive module.

In some aspects, the techniques described herein relate to a radio frequency front-end system wherein the at least one primary transmit and receive module further includes a single-pole double-throw switch configured to switch between a second antenna port of the at least one primary transmit and receive module and a third antenna port of the at least one primary transmit and receive module.

In some aspects, the techniques described herein relate to a radio frequency front-end system wherein a mid and high band primary transmit and receive module of the radio frequency front-end system is adapted to send a sounding reference signal subsequently at different time slots via all antennas of the antenna array connected to the radio frequency front-end system to a base station.

In some aspects, the techniques described herein relate to a mobile device, including: an antenna array having a plurality of antennas; and a radio frequency front-end system having a plurality of mid and high band modules, each mid and high band module of the plurality of mid and high band modules including at least two antenna ports, and at least one controllable switch configured to switch between the at least two antenna ports to provide a signal path from the mid and high band module to a selected antenna of the antenna array.

In some aspects, the techniques described herein relate to a mobile device further including a transceiver connected to the plurality of mid and high band modules.

In some aspects, the techniques described herein relate to a mobile device further including a base band modem including a master controller connected via an internal interface to integrated module controllers of the plurality of mid and high band modules to control the controllable switches integrated in the plurality of mid and high band modules.

In some aspects, the techniques described herein relate to a mobile device wherein the at least one controllable switch integrated in the plurality of mid and high band modules has a loss of less than 0.5 dB.

In some aspects, the techniques described herein relate to a mobile device wherein the antenna array includes a multi-input and multi-output antenna array.

In some aspects, the techniques described herein relate to a mobile device wherein the multi-input and multi-output antenna array includes four multi-input and multi-output antennas.

In some aspects, the techniques described herein relate to a radio frequency front-end system including: a primary transmit and receive module including at least one transmit path, at least one first receive path, at least two first antenna ports, and at least one first controllable switch configured to switch between the at least two first antenna ports; and a first secondary radio frequency module including at least one second receive path, at least two second antenna ports, and at least one second controllable switch configured to switch between the at least two second antenna ports, a first antenna port of the at least two first antenna ports configured for direct connection to a first antenna of an antenna array connected to the radio frequency front-end system, a second antenna port of the at least two first antenna ports configured for indirect connection to a second antenna of the antenna array via the first secondary radio frequency module.

In some aspects, the techniques described herein relate to a radio frequency front-end system wherein the primary transmit and receive module includes a first integrated module controller configured to control the at least one first controllable switch in response to input received from an external master controller.

In some aspects, the techniques described herein relate to a radio frequency front-end system wherein the first secondary radio frequency module is a multi-input and multi-output (MIMO) module.

In some aspects, the techniques described herein relate to a radio frequency front-end system wherein the first secondary radio frequency module is a diversity receive module.

In some aspects, the techniques described herein relate to a radio frequency front-end system wherein the diversity receive module is configured for direct connection to the second antenna of the antenna array and to a third antenna of the antenna array.

In some aspects, the techniques described herein relate to a radio frequency front-end system further including a second secondary radio frequency module, the at least two first antenna ports of the primary transmit and receive module further including a third antenna port, the third antenna port being configured for indirect connection via the second secondary radio frequency module to a third antenna of the antenna array.

In some aspects, the techniques described herein relate to a radio frequency front-end system wherein the first secondary radio frequency module is a multi-input and multi-output (MIMO) module configured for direct connection to the second antenna, and the second secondary radio frequency module is a diversity receive module configured for direct connection to the third antenna.

In some aspects, the techniques described herein relate to a radio frequency front-end system wherein the at least one first controllable switch includes a first switch and a second switch, the first switch coupled on one side to the at least one transmit path and to the at least one first receive path, and on another side to the first antenna port and to the second switch, the second switch coupled between the first switch and the second and third antenna ports.

In some aspects, the techniques described herein relate to a radio frequency front-end system wherein the radio frequency front-end system is adapted to send a sounding reference signal to a base station at different time slots via the first antenna and the second antenna, through the direct connection to the first antenna of the primary transmit and receive module, and through the indirect connection to the second antenna of the primary transmit and receive module.

In some aspects, the techniques described herein relate to a mobile device including: a first antenna and a second antenna; a transceiver; and a radio frequency front end system coupled to the transceiver, the radio frequency front end system including a primary transmit and receive module including at least one transmit path, at least one first receive path, at least two first antenna ports, and at least one first controllable switch configured to switch between the at least two first antenna ports, the radio frequency front end system further including a first secondary radio frequency module including at least one second receive path, at least two second antenna ports, and at least one second controllable switch configured to switch between the at least two second antenna ports, a first antenna port of the at least two first antenna ports configured for direct connection to the first antenna, a second antenna port of the at least two first antenna ports configured for indirect connection to the second antenna.

In some aspects, the techniques described herein relate to a mobile device wherein the primary transmit and receive module includes a first integrated module controller configured to control the at least one first controllable switch in response to input received from an external master controller.

In some aspects, the techniques described herein relate to a mobile device wherein the first secondary radio frequency module is a multi-input and multi-output (MIMO) module.

In some aspects, the techniques described herein relate to a mobile device wherein the first secondary radio frequency module is a diversity receive module.

In some aspects, the techniques described herein relate to a mobile device further including a third antenna and wherein the diversity receive module is configured for direct connection to the second antenna and to the third antenna.

In some aspects, the techniques described herein relate to a mobile device further including a third antenna and wherein the radio frequency front end system further includes a second secondary radio frequency module, the at least two first antenna ports of the primary transmit and receive module further including a third antenna port, the third antenna port being configured for indirect connection via the second secondary radio frequency module to the third antenna.

In some aspects, the techniques described herein relate to a mobile device wherein the first secondary radio frequency module is a multi-input and multi-output (MIMO) module configured for direct connection to the second antenna, and the second secondary radio frequency module is a diversity receive module configured for direct connection to the third antenna.

In some aspects, the techniques described herein relate to a mobile device wherein the at least one first controllable switch includes a first switch and a second switch, the first switch coupled on one side to the at least one transmit path and to the at least one first receive path, and on another side to the first antenna port and to the second switch, the second switch coupled between the first switch and the second and third antenna ports.

In some aspects, the techniques described herein relate to a mobile device wherein the radio frequency front end system is adapted to transmit a sounding reference signal for delivery to a base station at different time slots via the first antenna and the second antenna, through the direct connection to the first antenna of the primary transmit and receive module, and through the indirect connection to the second antenna of the primary transmit and receive module.

In some aspects, the techniques described herein relate to a radio frequency front-end system including a plurality of radio frequency modules, each radio frequency module of the plurality of radio frequency modules including: at least two antenna ports; and at least one controllable switch configured to switch between the at least two antenna ports to provide a signal path from the radio frequency module to a selected antenna of an antenna array connected to the radio frequency front-end system.

In some aspects, the techniques described herein relate to a radio frequency front-end system wherein each of the plurality of radio frequency modules further includes an integrated module controller configured to control the at least one controllable switch.

In some aspects, the techniques described herein relate to a radio frequency front-end system wherein the integrated module controller is configured to control the at least one controllable switch in response to a control signal received from an external master controller.

In some aspects, the techniques described herein relate to a radio frequency front-end system wherein the plurality of radio frequency modules include at least one primary transmit and receive module configured to be switched for normal transmission of a transmission signal to a primary antenna of the antenna array being connected directly to an antenna port of the at least one primary transmit and receive module.

In some aspects, the techniques described herein relate to a radio frequency front-end system wherein the at least one primary transmit and receive module is configured to be switched for subsidiary transmission of a transmission signal to a secondary antenna of the antenna array connected indirectly to an antenna port of the at least one primary transmit and receive module by a signal path via one or more secondary radio frequency modules of the plurality of radio frequency modules.

In some aspects, the techniques described herein relate to a radio frequency front-end system wherein the plurality of radio frequency modules include radio frequency multi-input and multi-output modules configured to process a reception signal of an antenna of the antenna array.

In some aspects, the techniques described herein relate to a radio frequency front-end system wherein each radio frequency multi-input and multi-output module includes two antenna ports.

In some aspects, the techniques described herein relate to a radio frequency front-end system wherein the plurality of radio frequency modules includes at least one diversity receive module configured to process a reception signal of an antenna of the antenna array.

In some aspects, the techniques described herein relate to a radio frequency front-end system wherein the at least one diversity receive module includes two antenna ports.

In some aspects, the techniques described herein relate to a radio frequency front-end system wherein the at least one primary transmit and receive module includes three antenna ports, a first antenna port of the at least one primary transmit and receive module is connected directly to a primary antenna of the antenna array, and a second antenna port and a third antenna port of the at least one primary transmit and receive module are switchable via secondary radio frequency modules to secondary or tertiary antennas of the antenna array.

In some aspects, the techniques described herein relate to a radio frequency front-end system wherein the at least one controllable switch of each of the plurality of radio frequency modules includes a double-pole multi-throw switch controlled by an integrated module controller of each of the plurality of radio frequency modules.

In some aspects, the techniques described herein relate to a radio frequency front-end system wherein the at least one primary transmit and receive module includes a double-pole multi-throw switch configured to switch between a first antenna port of the at least one primary transmit and receive module connected directly to a primary antenna of the antenna array and a second or a third antenna port of the at least one primary transmit and receive module.

In some aspects, the techniques described herein relate to a radio frequency front-end system wherein the at least one primary transmit and receive module further includes a single-pole double-throw switch configured to switch between a second antenna port of the at least one primary transmit and receive module and a third antenna port of the at least one primary transmit and receive module.

In some aspects, the techniques described herein relate to a radio frequency front-end system wherein a radio frequency primary transmit and receive module of the radio frequency front-end system is adapted to send a sounding reference signal subsequently at different time slots via all antennas of the antenna array connected to the radio frequency front-end system to a base station.

In some aspects, the techniques described herein relate to a mobile device, including: an antenna array having a plurality of antennas; and a radio frequency front-end system having a plurality of radio frequency modules, each radio frequency module of the plurality of radio frequency modules including at least two antenna ports, and at least one controllable switch configured to switch between the at least two antenna ports to provide a signal path from the radio frequency module to a selected antenna of the antenna array.

In some aspects, the techniques described herein relate to a mobile device further including a transceiver connected to the plurality of radio frequency modules.

In some aspects, the techniques described herein relate to a mobile device further including a base band modem including a master controller connected via an internal interface to integrated module controllers of the plurality of radio frequency modules to control the controllable switches integrated in the plurality of radio frequency modules.

In some aspects, the techniques described herein relate to a mobile device wherein the at least one controllable switch integrated in the plurality of radio frequency modules has a loss of less than 0.5 dB.

In some aspects, the techniques described herein relate to a mobile device wherein the antenna array includes a multi-input and multi-output antenna array.

### BRIEF DESCRIPTION OF THE DRAWINGS

FIG. 1 is a block diagram of a conventional radio frequency front-end (RFFE) system.

FIG. 2 is a schematic diagram of one example of a communication network.

FIG. 3 shows a possible implementation of a MHB Primary TRX Module forming part of a radio frequency front-end (RFFE) system according to some embodiments of the present disclosure.

FIG. 4 shows a possible implementation of a MHB DRX Module forming part of a radio frequency front-end (RFFE) system according to some embodiments of the present disclosure.

FIG. 5 shows a possible implementation of a MHB (multi-input and multi-output) MIMO Module forming part of a radio frequency front-end (RFFE) system according to some embodiments of the present disclosure.

FIGS. 6A and 6B illustrate a first possible operation mode of a radio frequency front-end (RFFE) system according to some embodiments of the present disclosure.

FIGS. 7A and 7B illustrate a second possible operation mode of a radio frequency front-end (RFFE) system according to some embodiments of the present disclosure.

FIGS. 8A and 8B illustrate a third possible operation mode of a radio frequency front-end (RFFE) system according to some embodiments of the present disclosure.

FIGS. 9A and 9B illustrate a fourth possible operation mode of a radio frequency front-end (RFFE) system according to some embodiments of the present disclosure.

FIG. 10 is a schematic block diagram of a front-end architecture including a radio frequency front end system according to some embodiments of the present disclosure.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and developed 5G technology further in Release 16. Subsequent 3GPP releases will further evolve and expand 5G technology. 5G technology is also referred to herein as 5G New Radio (NR).

Preliminary specifications for 5G NR support a variety of features, such as communications over millimeter wave spectrum, beam forming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

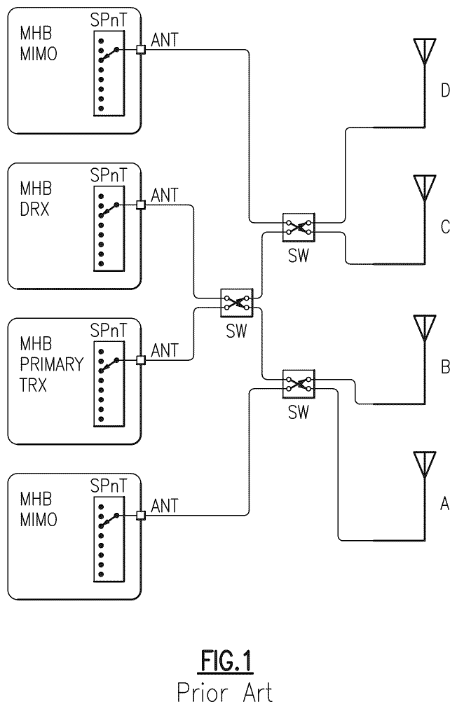

FIG. 1 shows a block diagram of the architecture of a conventional radio frequency front-end (RFFE) system used in an RF device, such as for example a mobile device. The RFFE system comprises different modules connected to an antenna array via switches. The antenna array includes four antennas A, B, C, and D.

The modules of the radio frequency front-end system shown in FIG. 1 comprise an MHB Primary TRX module, a MHB Diversity reception module (MHB DRX), and two MHB MIMO Modules. Each module of the radio frequency front-end system comprises an internal single-pole multiple-throw switch (SPnT) connected to a single antenna port (ANT) of the respective module.

As can be seen in FIG. 1, the signal path between the antenna port ANT of the MHB Primary TRX module and an antenna of the antenna array includes two external switches SWs. The signal path between the antenna port ANT of the MHB diversity reception module MHB DRX and an antenna of the antenna array includes also two external switches SWs. Each switch SW along the signal paths adds a signal loss of approximately 0.5 dB which reduces the signal sensitivity of the radio frequency front-end system significantly.

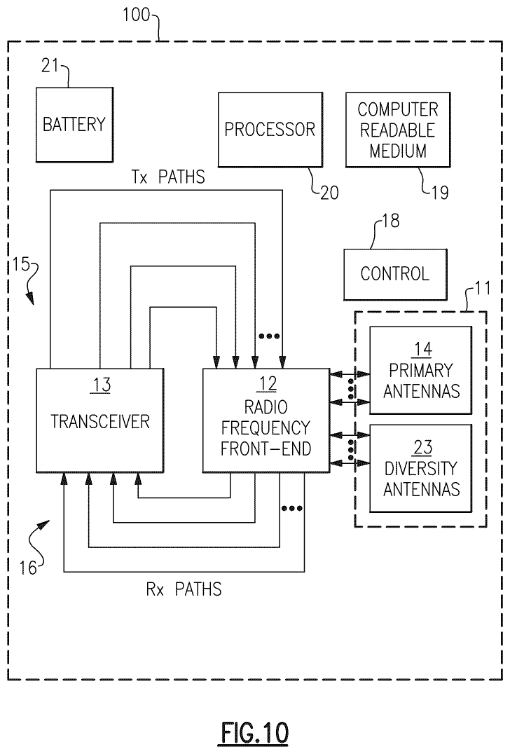

Referring to FIG. 10, a radio frequency (RF) device 100 can include multiple antennas for supporting communications. Additionally, the RF device 100 can include a radio frequency front end (RFFE) system 10 for processing signals received from and transmitted to the antennas. The RFFE system 10 can provide a number of functions, including, but not limited to, signal filtering, controlling component connectivity to the antennas, and/or signal amplification.

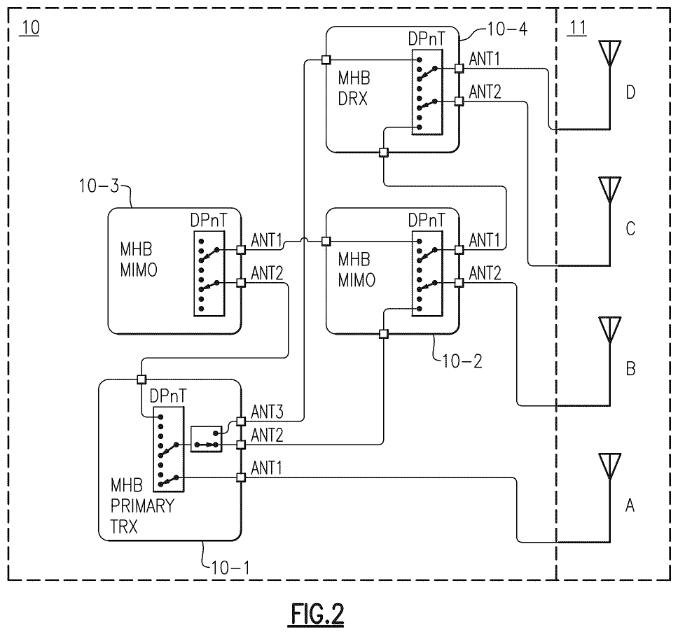

As illustrated in the embodiment shown in FIG. 2 an RFFE system 10 includes a plurality of mid and high band (MHB) modules 10-i. Each MHB module 10-i comprises at least one integrated controllable switch SW adapted to switch between at least two antenna ports (ANT) of the respective MHB module 10-i to provide a signal path from any MHB module 10-i to any antenna A, B, C, and/or D of an antenna array 11 connected to the RFFE system 10.

The RFFE system 10 shown in FIG. 2 can form part of an RF device 100 as illustrated in the block diagram of FIG. 10. The RF device 100 may for example be a mobile device such as a smartphone.

Each MHB module 10-1 can include an integrated module controller adapted to control the at least one internal switch SW (DPnT) integrated in the respective MHB module 10-i. The module controller integrated in the MHB module 10-i is adapted to control the at least one switch (DPnT) integrated in the respective MHB module 10-i in response to a control signal CTRL received from an external master controller. The external master controller can be integrated in the control component 18 of the RF device 100 shown in FIG. 10.

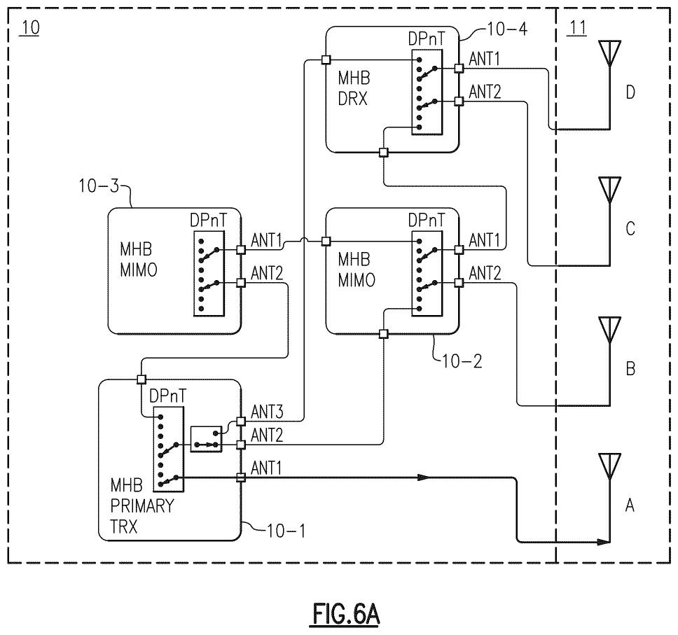

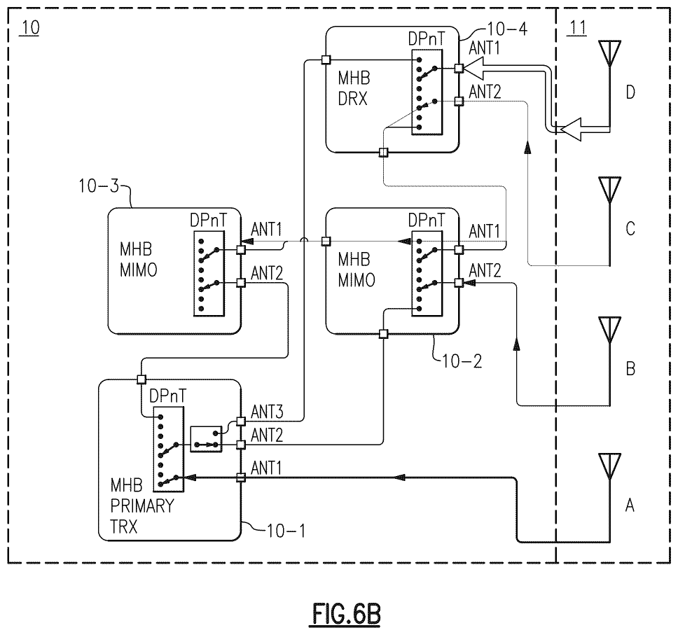

The MHB modules 10-i include at least one primary transmit and receive module (MHB Primary TRX) 10-1 switched for normal transmission of a transmission signal to a primary antenna A of the antenna array 11 as illustrated in FIG. 6A. The primary antenna A of the antenna array 11 may have a high antenna efficiency and may be connected directly to an antenna port ANT1 of the MHB Primary TRX module 10-1 as illustrated in FIG. 2.

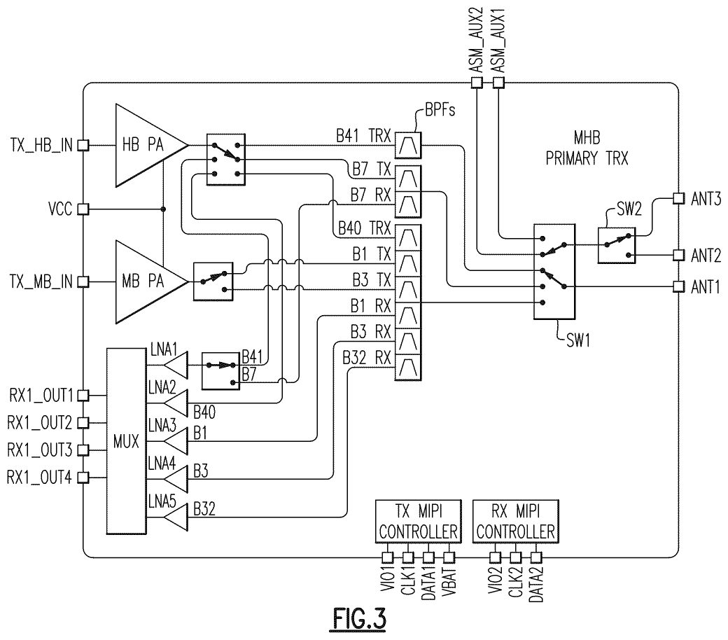

A possible implementation of the MHB Primary TRX module 10-1 is schematically illustrated in FIG. 3. The MHB Primary TRX module 10-1 is adapted to transmit signals and to receive signals. It includes a first switch SW1 and a second switch SW 2 between its band pass filters BPFs and its three antenna ports ANT1, ANT2, and ANT3, respectively. The MHB Primary TRX module 10-1 in the illustrated implementation includes, for example, two ASM auxiliary ports connected to the first switch SW1. For example, referring to FIG. 2, one of the two ASM auxiliary ports of the TRX module 10-1 can be connected to the ANT2 port of the MHB MIMO module 10-3. As shown in FIG. 3, the MHB Primary TRX module 10-1 can include an integrated TX mobile industry processer interface (MIPI) controller and an RX MIPI controller connected to an external master controller via an interface. At its transmission end, the MHB Primary TRX module 10-1 further includes a high band (HB) power amplifier (PA) and a mid band (MB) PA connected via switches to band pass filters for TX bands B. At its reception end, the MHB Primary TRX module 10-1 includes LNAs connected to a multiplexer MUX.

The MHB Primary TRX module 10-1 includes three antenna ports ANT1, ANT2, and ANT3, as illustrated in the example implementations of FIGS. 2 and 3. A first antenna port ANT1 of the MHB Primary TRX module 10-1 is connected directly to the primary antenna A of the antenna array 11 connected to the RFFE system 10. A second antenna port ANT2 and a third antenna port ANT3 of the MHB Primary TRX module 10-1 are switchable via other MHB modules to other antennas B, C, and/or D of the antenna array 11 connected to the RFFE system 10. The antenna array 11 connected to the RFFE system 10 may include a MIMO antenna array. In the illustrated example implementation of FIGS. 2 and 3, the MIMO antenna array 11 includes four antennas A, B, C, and D.

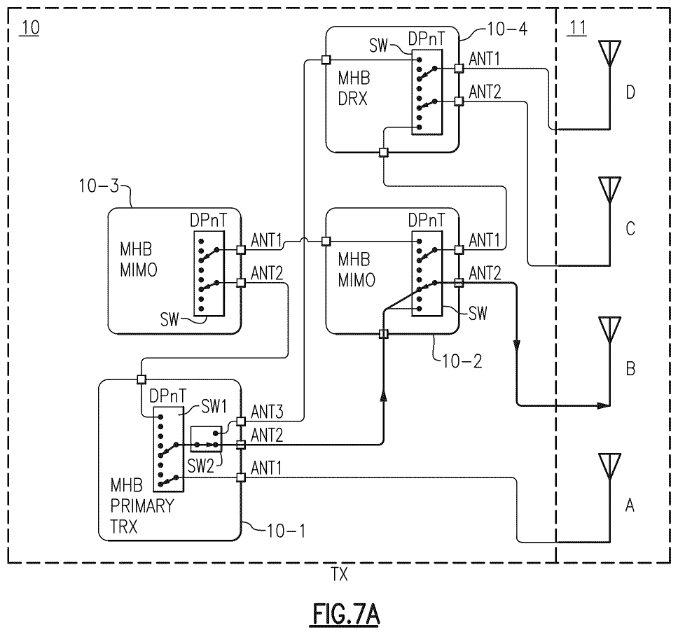

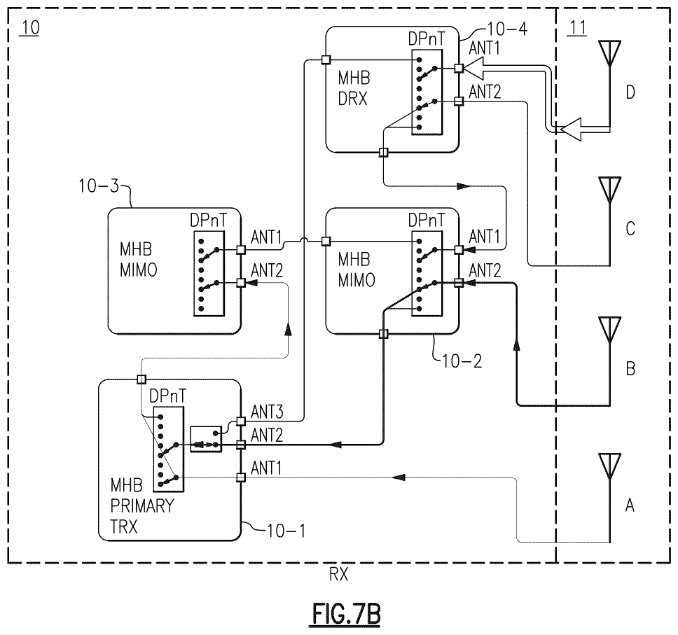

The MHB Primary TRX module 10-1 can be switched for subsidiary transmission of a transmission signal from the primary antenna A of the antenna array 11 to another secondary antenna B, C, or D of the antenna array 11 connected indirectly to another antenna port of the MHB Primary TRX module 10-1 by a signal path via other MHB modules of the RFFE system 10 as also illustrated in FIGS. 7A, 8A, and 9A.

For example, as depicted in FIG. 7A, the second antenna port ANT2 of the MHB Primary TRX module 10-1 is switched for signal transmission via MHB MIMO module 10-2 to the second antenna B of the antenna array 11. FIG. 7B shows the corresponding reception of signals from the antennas A, B, C, and D of the antenna array 11 by the MHB modules 10-1, 10-2, 10-3, and 10-4, respectively.

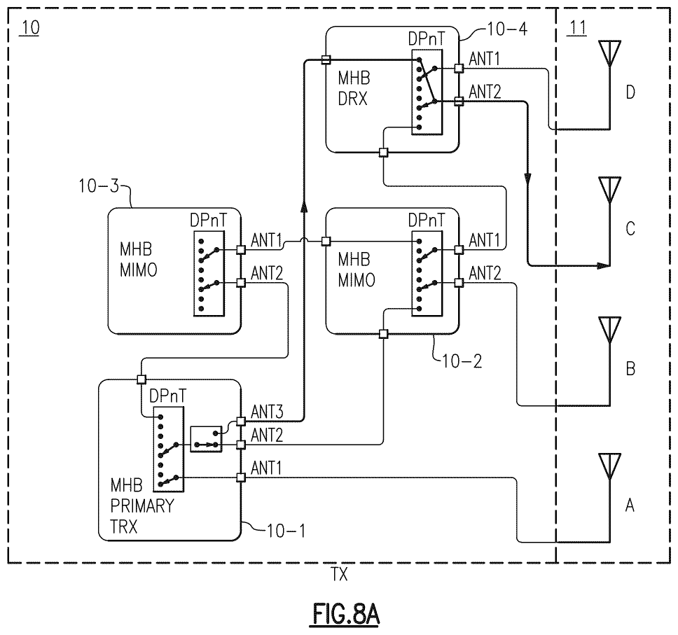

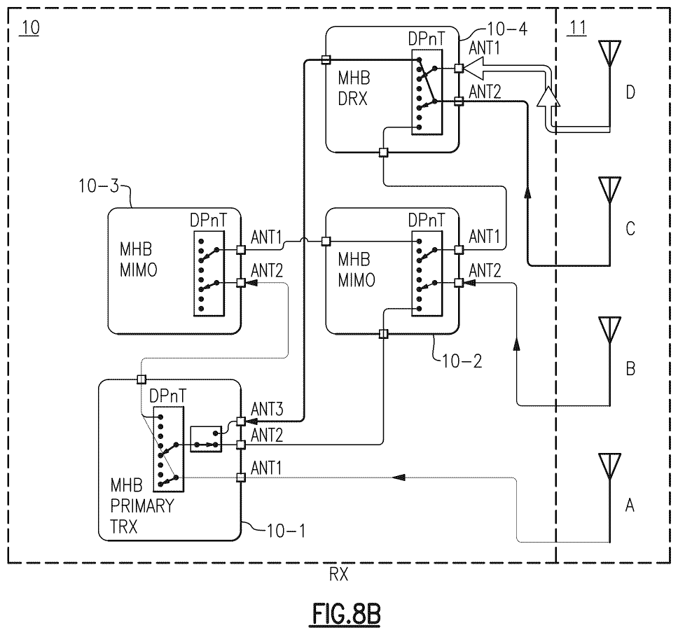

Further, as exemplarily depicted in FIG. 8A, the third antenna port ANT3 of the MHB Primary TRX module 10-1 is switched for signal transmission via MHB DRX module 10-4 to the third antenna C of the antenna array 11. FIG. 8B shows the corresponding reception of signals from the antennas A, B, C, and D of the antenna array 11 by the MHB modules 10-1, 10-2, 10-3, and 10-4, respectively.

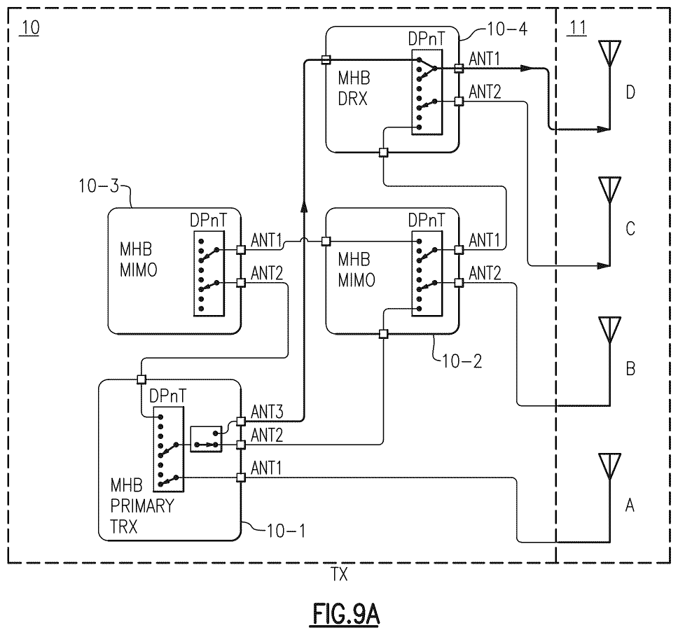

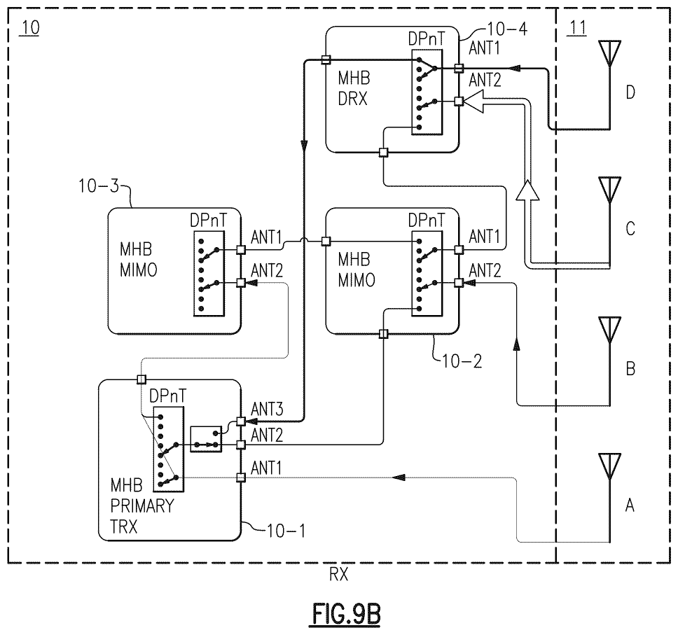

Further, as exemplarily depicted in FIG. 9A, the third antenna port ANT3 of the MHB Primary TRX module 10-1 is switched for signal transmission via the MHB DRX module 10-2 to the fourth antenna D of the antenna array 11. FIG. 9B shows the corresponding reception of signals from the antennas A, B, C, and D of the antenna array 11 by the modules 10-1, 10-2, 10-3, and 10-4, respectively.

As illustrated in FIGS. 6A, 7A, 8A, and 9A, the MHB Primary TRX module 10-1 can be switched to any antenna A, B, C, or D of the antenna array 11 during transmission (TX) via a signal path that does not include any external switches. As shown in the example implementation of FIG. 6A, the signal path between the first antenna port ANT1 the MHB Primary TRX module 10-1 and the primary antenna A does not comprise any switches. This (zero) signal loss is 1.0 dB less than in a conventional RFFE system having two cascaded external switches in the transmission signal path between the primary transmit and receive module (MHB Primary TRX) and the primary antenna A causing a signal loss of about 1.0 dB, as for example shown in FIG. 1.

The signal paths between the another antenna port ANT2, ANT3 of the MHB Primary TRX module 10-1 and any of the secondary antennas B, C, or D includes only one internal switch SW of another module 10-i as can be seen in FIGS. 7A, 8A, and 9A, leading to an additional signal loss of less or equal to 0.5 dB. This signal loss is 0.5 dB less than in a conventional RFFE system having two cascaded external switches in the transmission signal path between the MHB Primary TRX module and the respective secondary antenna A causing a signal loss of about 1.0 dB. The transmission signal paths from the between the MHB Primary TRX module and the respective secondary antenna B, C, or D is looped through another MHB module 10-i to minimize the signal loss caused by switches.

The MHB modules may include MHB MIMO modules 10-2 and 10-3, each MHB MIMO module 10-2, 10-3 being adapted to process a reception signal of an antenna of the antenna array 11. Each MHB MIMO module 10-2, 10-3 may include two antenna ports ANT1 and ANT2, respectively, as shown in FIG. 2. The MHB modules may include at least one MHB Diversity Receive Module (MHB DRX) 10-4 adapted to process a reception signal of any of the antennas of the antenna array 11.

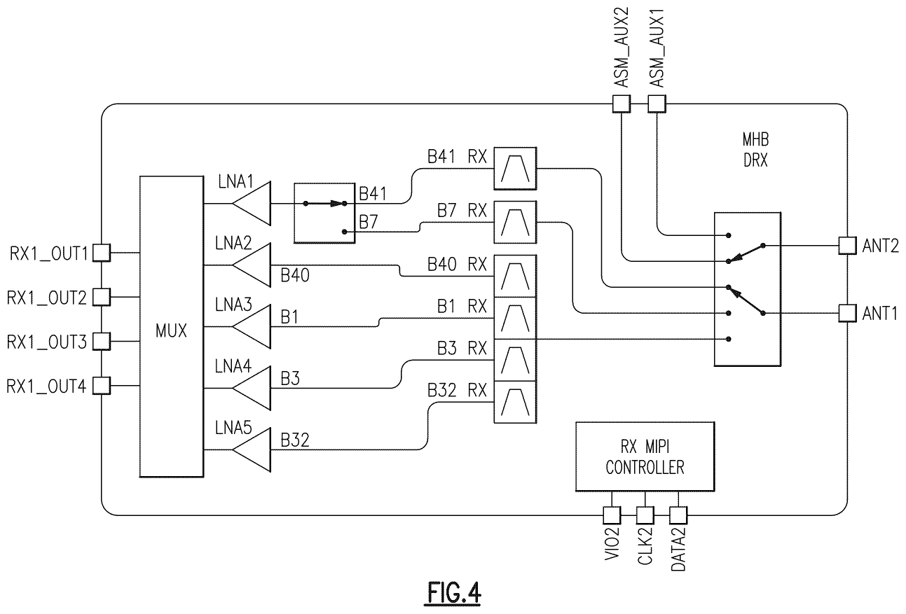

FIG. 4 shows a possible exemplary implementation of the MHB DRX module 10-4. The MHB DRX module 10-4 includes an internal switch SW controlled by an RX MIPI controller. The MHB DRX module 10-4 includes band pass filters BPFs for different frequency bands B as well as LNAs for signal amplification connected to a multiplexer MUX. The MHB DRX module 10-4 further includes two antenna ports ANT1 and ANT2 and two auxiliary antenna ports ASM AUX 1 and ASM AUX 2. Referring to FIG. 2, one of the auxiliary antenna ports of the MHB DRX module 10-4 can be connected to the ANT1 port of the MHB MIMO module 10-2.

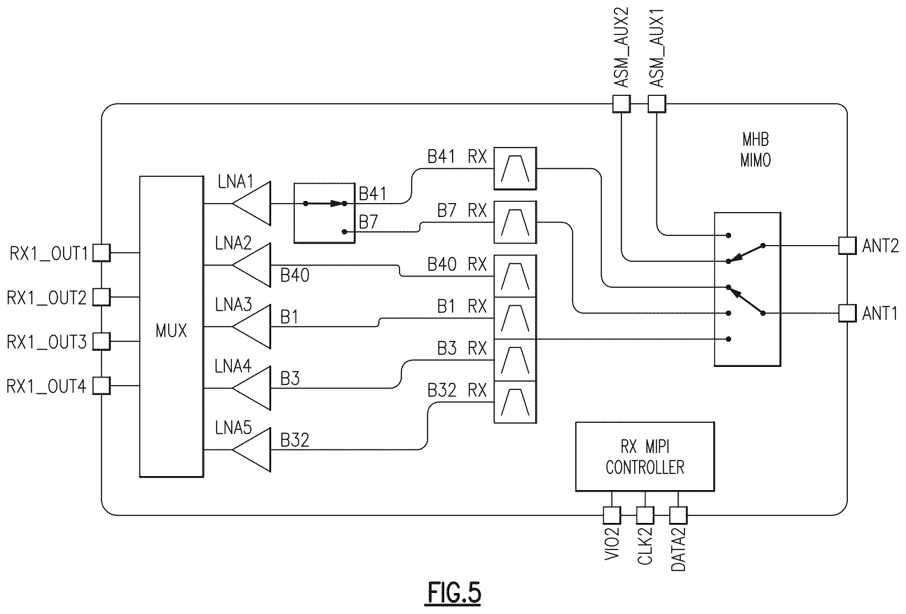

FIG. 5 shows a possible exemplary implementation of the MHB MIMO modules 10-2 and 10-3. The MHB MIMO modules 10-2 and 10-3 each include an internal switch controlled by an RX MIPI controller. The MHB MIMO modules 10-2 and 10-3 each include band pass filters BPFs for different frequency bands B as well as LNAs for signal amplification connected to a multiplexer MUX. The MHB MIMO modules 10-2 and 10-3 also include two antenna ports ANT1 and ANT2 and two auxiliary antenna ports ASM AUX 1 and ASM AUX 2. For example, referring to FIG. 2, one of the auxiliary antenna ports of the MHB MIMO module 10-2 may be connected to the ANT1 port of the other MHB MIMO module 10-3.

The at least one controllable switch SW included in the MHB Primary TRX module 10-1 may include a double-pole multi-throw (DPnT) switch controlled by an integrated module controller of the respective MHB module 10-i. In a possible implementation, the MHB Primary TRX module 10-1 includes a DPnT switch adapted to switch between the first antenna port ANT1 of the MHB Primary TRX module and the other antenna ports of the MHB Primary TRX module 10-1 as shown in FIGS. 2 and 3. In this implementation, the MHB Primary TRX module 10-1 further includes a single-pole double-throw (SP2T) switch SW2 adapted to switch between the second antenna port ANT2 of the MHB Primary TRX module 10-1 and a third antenna port ANT3 of the primary transmit and receive module (MHB Primary TRX) 10-1.

The module controller integrated in the MHB module 10-i is adapted to control the switch SW integrated in the respective MHB module 10-i in response to a control signal CTRL received from an external master controller which can be included in a base band modem via an internal interface.

In some implementations, the MHB Primary TRX module 10-1 may be adapted to send a sounding reference signal (SRS) subsequently at different time slots TSs via all antennas A, B, C, and D of the antenna array 11 connected to the RFFE system 10 to a base station. On the basis of the received SRS signals, the base station BS may be able to determine one or more channel properties of the transmission channel. Data transmitted by the base station BS is then pre-coded depending on the determined channel properties.

FIG. 10 schematically illustrates an RF device 100 having a radio frequency front-end (RFFE) system 10 with a plurality of MHB modules 10-i. The RF device 100 may for example be a mobile device. Each of the MHB modules 10-i includes at least one controllable switch SW adapted to switch between at least two antenna ports ANTs of the respective MHB module 10-i to provide a low loss signal path from any MHB module 10-i to any antenna A, B, C, and/or D of an antenna array 11 of the RF device 100 connected to the RFFE system 10.

The RF device 100 includes a transceiver 13 connected to the MHB modules 10-i. The RF device 100 can include a base band modem including a master controller connected via an internal interface to integrated module controllers of the MHB modules 10-i to control the controllable switches SW integrated in the respective MHB modules 10-i. For example, the at least one controllable switch SW integrated in the MHB modules 10-i incurs a loss of less than 0.5 dB.

The RFFE system 10 can be used to handle RF signals of a wide variety of types, including, but not limited to, wireless local area network (WLAN) signals, Bluetooth signals, and/or cellular signals. Additionally, the RFFE system 10 can be used to process signals of a wide range of frequencies. For example, the RFFE system 10 can operate using one or more low bands (LBs) (for example, RF signal bands having a frequency of 1 GHz or less), one or more mid bands (MBs) (for example, RF signal bands having a frequency between 1 GHz and 2.3 GHZ), and one or more high bands (HBs) (for example, RF signal bands having a frequency greater than 2.3 GHZ). The RFFE system 10 can be used in a wide variety of RF devices, including, but not limited to, smartphones, base stations, laptops, handsets, wearable electronics, and/or tablets.

The RFFE system 10 can be implemented to support a variety of features that enhance bandwidth and/or other performance characteristics of an RF device. In a possible implementation, the RFFE system 10 can be implemented to support carrier aggregation (CA), thereby providing flexibility to increase peak data rates. Carrier aggregation can be used for both Frequency Division Duplexing (FDD) and Time Division Duplexing (TDD), and may be used to aggregate a plurality of carriers or channels, for instance up to five carriers. Carrier aggregation includes contiguous aggregation, in which contiguous carriers within the same operating frequency band are aggregated. Carrier aggregation can also be non-contiguous, and can include carriers separated in frequency within a common band or in different bands.

The RFFE system 10 is implemented to support multi-input and multi-output (MIMO) communications to increase throughput and enhance mobile broadband service. MIMO communications use multiple antennas for communicating multiple data streams over a single radio frequency channel. MIMO communications benefit from higher signal to noise ratio, improved coding, and/or reduced signal interference due to spatial multiplexing differences of the radio environment.

MIMO order refers to a number of separate data streams sent or received. For instance, a MIMO order for downlink communications can be described by a number of transmit antennas of a base station BS and a number of receive antennas for user equipment (UE), such as a mobile device. For example, two-by-two (2×2) RX MIMO (also referred to herein as second order receive MIMO) refers to MIMO downlink communications using two base station antennas and two UE antennas. Additionally, four-by-four (4×4) RX MIMO (also referred to herein as fourth order receive MIMO) refers to MIMO downlink communications using four base station antennas and four UE antennas.

The RFFE system 10 can support carrier aggregation and multi-order MIMO and can be used in RF devices that operate with wide bandwidth. For example, such RFFE systems can be used in applications servicing multimedia content streaming at high data rates.

In some embodiments, a front-end architecture can be configured to support MB-MB and MB-HB uplink carrier aggregation. Such uplink carrier aggregation support can be implemented with some or all of the foregoing MHB downlink carrier aggregation and 4×4 MIMO support described in the above-referenced applications, independently, or any combination thereof.

The RFFE system 10 can also exhibit excellent performance when carrier aggregation and/or MIMO functionality is disabled. For instance, receive filters associated with downlink carrier aggregation and/or MIMO can be switch combined such that they are not present in a signal path when operating using a single frequency carrier. Accordingly, certain embodiments herein not only can be used to provide an RF device with high performance carrier aggregation and RX MIMO, but also robust single carrier performance when the RF device operates with carrier aggregation and MIMO features disabled.

FIG. 10 is a schematic block diagram of an RF device 100 as one example of a wireless or mobile device. The RF device 100 can include an RFFE system 10 implementing one or more features of the present disclosure.

The example RF device 100 depicted in FIG. 10 can represent a multi band and/or multi-mode device such as a multi-band/multi-mode mobile phone. By way of examples, Global System for Mobile (GSM) communication standard is a mode of digital cellular communication that is utilized in many parts of the world. GSM mode mobile phones can operate at one or more of four frequency bands: 850 MHZ (approximately 824 849 MHz for Tx, 869-894 MHz for Rx), 900 MHZ (approximately 880-915 MHz for Tx, 925-960 MHz for Rx), 1800 MHZ (approximately 1710-1785 MHz for Tx, 1805-1880 MHz for Rx), and 1900 MHz (approximately 1850-1910 MHz for Tx, 1930-1990 MHz for Rx). Variations and/or regional/national implementations of the GSM bands are also utilized in different parts of the world.

Code division multiple access (CDMA) is another standard that can be implemented in the RF device 100. In certain implementations, CDMA devices can operate in one or more of 800 MHZ, 900 MHZ, 1800 MHz and 1900 MHz bands, while certain W-CDMA and Long Term Evolution (LTE) devices can operate over, for example, 22 or more radio frequency spectrum bands.

Transmit and receive modules 10-i of the present disclosure can be used within the RF device 100 implementing the foregoing example modes and/or bands, and in other communication standards. For example, 3G, 4G, LTE, and Advanced LTE are non-limiting examples of such standards.

In the illustrated embodiment of FIG. 10, the RF device 100 includes an RFFE system 10 having one or more features of this disclosure, a transceiver 13, a control component 18, a computer readable medium 19, a processor 20, and a battery 21. The antenna array 11 can also comprise primary antennas 14 and diversity antennas 23.

The transceiver 13 of the RF device 100 can generate RF signals for transmission via the primary antennas 14 and/or the diversity antennas 23. Furthermore, the transceiver 13 can receive incoming RF signals from the primary antennas 14 and/or the diversity antennas 23. It will be understood that various functionalities associated with transmitting and receiving of RF signals can be achieved by one or more components that are collectively represented in FIG. 10 as the transceiver 13. For example, a single component can be configured to provide both transmitting and receiving functionalities. In another example, transmitting and receiving functionalities can be provided by separate components.

In FIG. 10, one or more output signals from the transceiver 13 are depicted as being provided to the RFFE system 10 via one or more transmission paths 15. In the example shown, different transmission paths 15 can represent output paths associated with different bands and/or different power outputs. For instance, the two different paths shown can represent paths associated with different power outputs (e.g., low power output and high power output), and/or paths associated with different bands. Although FIG. 10 illustrates a configuration using multiple transmission paths 15, the RF device 100 can be adapted to include more or fewer transmission paths 15.

In FIG. 10, one or more receive signals are depicted as being provided from the RFFE system 10 to the transceiver 13 via one or more receiving (RX) paths 16. In the example shown, different receiving paths 16 can represent paths associated with different bands. For example, the four example paths 16 shown in FIG. 10 can represent quad band capability that some mobile devices are provided with. Although FIG. 10 illustrates a configuration using four receiving paths 16, the RF device 100 can be adapted to include more or fewer receiving paths 16.

As shown in FIG. 10, the RFFE system 10 is adapted to control communications between the transceiver 13 of the RF device 100 and the primary antennas 14 and diversity antennas 23 which can comprise an antenna array 11 with four antennas A, B, C, and D as illustrated in the embodiment of FIG. 2. The RFFE system 10 can provide a number of functionalities associated with, for example, MIMO communications, switching between different bands, carrier aggregation, switching between different power modes, filtering of signals, duplexing of signals, and/or some combination thereof.

The illustrated control component 18 can be provided for controlling various control functionalities associated with operations of the RFFE system 12 and/or other operating component(s). For example, the control component 18 can provide control signals to the RFFE system 10 to control electrical connectivity to the antennas A, B, C, and D of the antenna array 11 for instance, by setting states of switches.

In certain embodiments, the processor 20 of the RF device 100 shown in FIG. 10 can be configured to facilitate implementation of various processes on the RF device 100. The processor 20 can be a general purpose computer, special purpose computer, or other programmable data processing apparatus. In certain implementations, the RF device 100 can include a computer readable memory 19, which can include computer program instructions that may be provided to and executed by the processor 20.

The battery 21 of the RF device 100 can be any suitable battery for use in the RF device 100, including, for example, a lithium-ion battery.

In some implementations, the illustrated RF device 100 shown in FIG. 10 may include diversity antennas 23 to aid in improving the quality and reliability of a wireless link relative to a configuration in which a RF device only includes primary antennas. For example, including the diversity antennas 23 can reduce line of sight losses and/or mitigate the impacts of phase shifts, time delays, and/or distortions associated with signal interference of the primary antennas 14. Thus, the transceiver 13 of the RF device 100 processes the signals received by the primary antennas 14 and diversity antennas 23 to obtain a receive signal of higher energy and/or improved fidelity relative to a configuration using only primary antennas 14.

The RFFE system 10 of FIG. 2 can be implemented in accordance with one or more features of the present disclosure. Although the RF device 100 of FIG. 10 illustrates one example of an RF device that can include an RFFE system 10 implemented in accordance with the present disclosure, the teachings herein are applicable to a wide variety of RF devices. Accordingly, the RFFE system 10 can be used in other implementations of RF devices. It will be understood that the example front-end architecture of FIG. 2 may be adapted to provide support for other bands utilizing one or more features of the present disclosure.

For the purpose of description, it will be understood that low band (LB), mid band (MB), and high band (HB) can include frequency bands associated with such bands. Such frequency bands can include cellular frequency bands. It will be understood that at least some of the bands can be divided into sub-bands. Some of the embodiments described above have provided examples in connection with mobile devices. However, the principles and advantages of the embodiments can be used for any other systems or apparatus that have needs for RFFE systems.

Thus, aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece or smart eyeglasses or virtual reality equipment, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, IoT radios, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front-end system comprising:
a primary transmit and receive module including at least one transmit path, at least one first receive path, at least two first antenna ports, and at least one first controllable switch configured to switch between the at least two first antenna ports; and
a first secondary radio frequency module including at least one second receive path, at least two second antenna ports, and at least one second controllable switch configured to switch between the at least two second antenna ports, a first antenna port of the at least two first antenna ports configured for direct connection to a first antenna connected to the radio frequency front-end system, a second antenna port of the at least two first antenna ports configured for indirect connection, via the first secondary radio frequency module, to a second antenna connected to the radio frequency front-end system.

2. The radio frequency front-end system of claim 1 wherein the primary transmit and receive module includes a first integrated module controller configured to control the at least one first controllable switch in response to input received from an external master controller.

3. The radio frequency front-end system of claim 1 wherein the first secondary radio frequency module is a multi-input and multi-output (MIMO) module.

4. The radio frequency front-end system of claim 1 wherein the first secondary radio frequency module is a diversity receive module.

5. The radio frequency front-end system of claim 4 wherein the diversity receive module is configured for direct connection to the second antenna to a third antenna connected to the radio frequency front-end system.

6. The radio frequency front-end system of claim 1 further comprising a second secondary radio frequency module, the at least two first antenna ports of the primary transmit and receive module further including a third antenna port, the third antenna port being configured for indirect connection via the second secondary radio frequency module to a third antenna connected to the radio frequency front-end system.

7. The radio frequency front-end system of claim 6 wherein the first secondary radio frequency module is a multi-input and multi-output (MIMO) module configured for direct connection to the second antenna, and the second secondary radio frequency module is a diversity receive module configured for direct connection to the third antenna.

8. The radio frequency front-end system of claim 6 wherein the at least one first controllable switch includes a first switch and a second switch, the first switch coupled on one side to the at least one transmit path and to the at least one first receive path, and on another side to the first antenna port and to the second switch, the second switch coupled between the first switch and the second and third antenna ports.

9. The radio frequency front-end system of claim 1 wherein the radio frequency front-end system is adapted to send a sounding reference signal to a base station at different time slots via the first antenna and the second antenna, through the direct connection to the first antenna of the primary transmit and receive module, and through the indirect connection to the second antenna of the primary transmit and receive module.

10. A mobile device comprising:
a first antenna and a second antenna;
a transceiver; and
a radio frequency front end system coupled to the transceiver, the radio frequency front end system including a primary transmit and receive module including at least one transmit path, at least one first receive path, at least two first antenna ports, and at least one first controllable switch configured to switch between the at least two first antenna ports, the radio frequency front end system further including a first secondary radio frequency module including at least one second receive path, at least two second antenna ports, and at least one second controllable switch configured to switch between the at least two second antenna ports, a first antenna port of the at least two first antenna ports configured for direct connection to the first antenna, a second antenna port of the at least two first antenna ports configured for indirect connection to the second antenna.

11. The mobile device of claim 10 wherein the primary transmit and receive module includes a first integrated module controller configured to control the at least one first controllable switch in response to input received from an external master controller.

12. The mobile device of claim 10 wherein the first secondary radio frequency module is a multi-input and multi-output (MIMO) module.

13. The mobile device of claim 10 wherein the first secondary radio frequency module is a diversity receive module.

14. The mobile device of claim 13 further comprising a third antenna and wherein the diversity receive module is configured for direct connection to the second antenna and to the third antenna.

15. The mobile device of claim 10 further comprising a third antenna and wherein the radio frequency front end system further includes a second secondary radio frequency module, the at least two first antenna ports of the primary transmit and receive module further including a third antenna port, the third antenna port being configured for indirect connection via the second secondary radio frequency module to the third antenna.

16. The mobile device of claim 15 wherein the first secondary radio frequency module is a multi-input and multi-output (MIMO) module configured for direct connection to the second antenna, and the second secondary radio frequency module is a diversity receive module configured for direct connection to the third antenna.

17. The mobile device of claim 15 wherein the at least one first controllable switch includes a first switch and a second switch, the first switch coupled on one side to the at least one transmit path and to the at least one first receive path, and on another side to the first antenna port and to the second switch, the second switch coupled between the first switch and the second and third antenna ports.

18. The mobile device of claim 10 wherein the radio frequency front end system is adapted to transmit a sounding reference signal for delivery to a base station at different time slots via the first antenna and the second antenna, through the direct connection to the first antenna of the primary transmit and receive module, and through the indirect connection to the second antenna of the primary transmit and receive module.

19. A radio frequency front-end system comprising a plurality of radio frequency modules, each radio frequency module of the plurality of radio frequency modules including:
at least two antenna ports; and
at least one controllable switch configured to switch between the at least two antenna ports to provide a signal path from the radio frequency module to a selected antenna connected to the radio frequency front-end system.

20. The radio frequency front-end system of claim 19 wherein the plurality of radio frequency modules include at least one primary transmit and receive module configured to be switched for normal transmission of a transmission signal to a primary antenna connected directly to an antenna port of the at least one primary transmit and receive module.
